(19) United States
(12) Patent Application Publication
(10) Pub. No.: US 2006/0074585 A1
(43) Pub. Date: Apr. 6, 2006

(54) Verifying heat dissipation apparatus in a data processing system

(76) Inventors: Kevin Michael Reinberg, Durham, NC (US); James Stephen Rutledge, Durham, NC (US)

Correspondence Address: LALLY & LALLY, L.L.P., P. O. BOX 684749, AUSTIN, TX, 78768-4749, US

(21) Appl. No.: 10/958,917

(22) Filed: Oct. 5, 2004

(51) Int. Cl. G01K 1/00

(52) U.S. Cl. 702/130

(57) ABSTRACT

A data processing system includes a microprocessor connected to a circuit board and a fansink positioned on the microprocessor. The system includes dedicated code that causes the microprocessor to draw a predetermined level of power. A fan speed required to maintain the microprocessor at a targeted temperature while the microprocessor is drawing the predetermined power level is then determined. If the required fan speed level exceeds the expected fan speed, corrective action is taken. Exercising the microprocessor may include executing a dedicated piece of code continuously until the microprocessor temperature stabilizes. The system may further include a stored table of empirically determined expected fan speed values that is indicative of the expected fan speed for various ambient temperatures and microprocessor temperatures. Alternatively, the system may generate an algorithm during an initial boot of the system and use the algorithm to derive the expected fan speed values during subsequent operation.

### BACKGROUND

1. Field of the Present Invention

The present invention is in the field of data processing systems and, more particularly, heat dissipation and cooling systems associated with such systems.

2. History of Related Art

Heat dissipation is an important design consideration for microprocessor-based data processing systems. During operation, microelectronic components generate heat that must be adequately dissipated to avoid performance degradation and catastrophic failures. Heat dissipation in most conventional desktop, notebook, and even server systems is achieved with heatsinks and air-moving fans.

In a conventional desktop system, for example, a “fansink” is often mounted over the system's microprocessor. The fansink includes a heat sink in contact with the microprocessor package and a fan mounted over the heat sink. The air flow provided by the fan, improves the heat sink's capacity to draw thermal energy away from the microprocessor package.

During the course of normal operation, contaminants accumulate within a data processing system chassis. These contaminants consist largely of dust and other small environmental particles. Environmental contaminants can have a negative impact on the heat dissipation system or mechanism within a system.

If the heat dissipation system degrades or fails entirely, the microprocessor and other components are placed in jeopardy. It would be desirable therefore, to implement a system or technique to monitor or verify the integrity of the heat dissipation mechanism. Unfortunately, cost and space considerations do not generally permit the use of any mechanism that requires additional hardware components within the system. Nor do considerations of system performance permit the use of a heat dissipation monitoring technique that requires significant processing bandwidth. It would be further desirable, therefore, if the implemented solution did not require significant additional hardware and did not have a significant impact on system performance.

### SUMMARY OF THE INVENTION

The identified objectives are achieved according to one embodiment of the invention with a data processing system that includes a microprocessor connected to a circuit board and a fansink positioned on the microprocessor. The system includes dedicated code that causes the microprocessor to draw a predetermined level of power. A fan speed required to maintain the microprocessor at a targeted temperature while the microprocessor is drawing the predetermined power level is then determined. If the required fan speed level exceeds the expected fan speed, corrective action is taken. Exercising the microprocessor may include executing a dedicated piece of code continuously until the microprocessor temperature stabilizes. The system may further include a stored table of empirically determined expected fan speed values that is indicative of the expected fan speed for various ambient temperatures and microprocessor temperatures. Alternatively, the system may generate an algorithm during an initial boot of the system and use the algorithm to derive the expected fan speed values during subsequent operation.

### BRIEF DESCRIPTION OF THE DRAWINGS

Other objects and advantages of the invention will become apparent upon reading the following detailed description and upon reference to the accompanying drawings in which:

FIG. 1 is an embodiment of a data processing system of the present invention;

FIG. 2 depicts selected elements of the system of FIG. 1;

FIG. 3 is a conceptual depiction of a heat dissipation verification table according to one embodiment of the invention;

FIG. 4 is a conceptual depiction of an algorithmically derived heat dissipation plot according to one embodiment of the invention; and

FIG. 5 is a flow diagram of a method of verifying the efficiency of a heat dissipation system within a data processing system according to an embodiment of the present invention.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

Generally speaking, the present invention contemplates a mechanism and technique for verifying the integrity and efficiency of the heat dissipation mechanism within a data processing system such as a desktop or laptop computer. The system includes at least one heat generating electronic component such as a microprocessor connected to a planar or printed circuit board. A fansink assembly is positioned over the microprocessor or other electronic component so that the fansink contacts or is in very close proximity to the microprocessor. The system preferably includes at least two temperature sensors, a first temperature sensor positioned within the system chassis to monitor the ambient temperature and a second temperature sensor to provide an indication of the microprocessor temperature.

The system includes a software routine that, when executed, causes the microprocessor to draw power at a known rate. This software routine, referred to herein as thermal code, is executed at the beginning of a heat dissipation verification routine. Sufficient time is given after initiating the thermal code to permit the thermal properties of the system to stabilize. Following thermal stabilization, the ambient temperature is determined from the first sensor. With the ambient temperature known, an expected fansink fan speed is determined. The expected fansink fan speed represents the fan speed that is expected to provided sufficient cooling or thermal dissipation of the microprocessor at the determined ambient temperature.

The expected fan speed may be derived from fan speed values measured on similar or identical systems under highly controlled conditions. The experimentally determined fan speed values may be stored in a table that is consulted by the system during a thermal verification routine. In other embodiments, the system may generate its own expected values, when the system is first booted, by recording the actual fan speed required to achieved a targeted microprocessor temperature at the recorded ambient temperature. Under the assumption that the initial condition of the system is substantially free of environmental contaminants, the derived value of the expected fan speed serves as a proxy for the fan speed values determined experimentally under “laboratory” conditions.

An actual fan speed is determined by adjusting the fansink fan speed until the actual microprocessor temperature reaches the targeted microprocessor temperature. The actual fan speed required to achieve adequate cooling of the microprocessor is then compared to the expected fan speed. If the actual fan speed is higher than the expected fan speed, corrective action of some kind is undertaken. The corrective action might vary anywhere from issuing a user alert to shutting the system down.

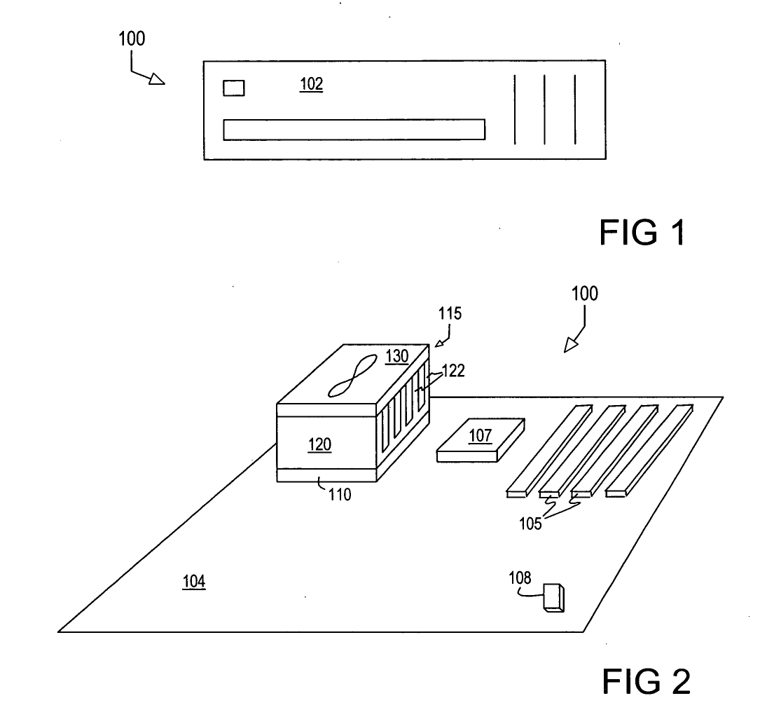

Referring now to the drawings, FIG. 1 and FIG. 2 depict an embodiment of a data processing system 100 according to the present invention. In the depicted embodiment, data processing system 100 is a desktop or server computer that includes a chassis 102 and a planar or printed circuit board 104. Printed circuit board 104 is positioned within and attached to chassis 102. Various electronic components are connected to printed circuit board 104 including a microprocessor 110 and a discreet transistor 108. Other components are also attached to printed circuit board 104 including system memory modules 105, a non-volatile storage element 107 including a system BIOS, and other elements (not depicted) include a chipset associated with microprocessor 110, connectors for attaching expansion adapters such as graphics adapters, hard disk adapters, network interface adapters, and so forth, all as will be familiar to those knowledgeable in the design of microprocessor-based computer systems. Moreover, although FIG. 1 depicts a desktop-like chassis 102, the invention is equally applicable to other types of systems including notebook computers and even handheld data processing devices such as PDA's.

As shown in FIG. 2, microprocessor 110 is attached to printed circuit board 104 and a fansink 115 is attached to microprocessor 110. Fansink 115 includes a heat sink 120 attached to microprocessor 110 and a variable-speed fan 130 positioned over heat sink 120 and configured to move air either towards or away from heat sink 120. Heat sink 120 is a conventional heat sink comprised of a thermally conductive material such as aluminum that contacts or is in very close proximity to a packaging surface of microprocessor 110. In some embodiments, for example, a thermal paste and/or an adhesive film may exist between heat sink 120 and microprocessor 110. The depicted embodiment of heat sink 120 includes a plurality of fins 122 designed to increase the surface area of heat sink 120 and thereby achieve greater heat dissipation capacity although the precise configuration of heat sink 120 is an implementation detail. The speed (angular velocity) of fan 130 is adjustable by microprocessor 110.

Data processing system 100 includes at least two temperature sensing devices or mechanisms. Preferably a first temperature sensor is positioned within chassis 102 to provide a measure of the ambient temperature within the system while a second temperature sensor is positioned to provide a measure of the microprocessor's temperature. The microprocessor's temperature may refer to the microprocessor's junction temperature or case temperature depending upon the implementation.

In the depicted embodiment, the first temperature sensor is provided via discreet transistor 108 and the second temperature sensor is provided via a transistor integrated within microprocessor 110. Discreet transistor 108 is preferably positioned within chassis 102 and on printed circuit board 104 where the surrounding temperature reflects the ambient temperature within chassis 102. In one embodiment, for example, transistor 108 is positioned in proximity to external air flow vents of chassis 102.

Outputs of discreet transistor 108 and the integrated transistor of microprocessor 110 may be accessed by microprocessor 110 and used to determine the temperature. In one implementation, the voltage across or current through a pair of output signals from discreet transistor 108 provide an indication of the temperature in proximity to transistor 108 and, similarly, a pair of outputs from the integrated transistor provide an indication of the microprocessor temperature. The outputs from discreet transistor 108 and from the integrated transistor in microprocessor 110 may be accessed by or connected to microprocessor 110 for purposes of determining the ambient temperature and the microprocessor temperature.

Data processing system 100 includes storage elements that contain data or information that the system uses to verify the functionality of the system's heat dissipation mechanism. The necessary storage elements may be within nonvolatile chip 107, within another nonvolatile chip such as a flash memory device (not depicted), or within a hard disk (not depicted) to which microprocessor 110 has access. The stored data is used by system 100 to determine an expected speed for fan 130. The expected fan speed represents the fan speed that is required to cool microprocessor 110 adequately under conditions that are known to be or highly likely to be ideal with respect to environmental contaminants.

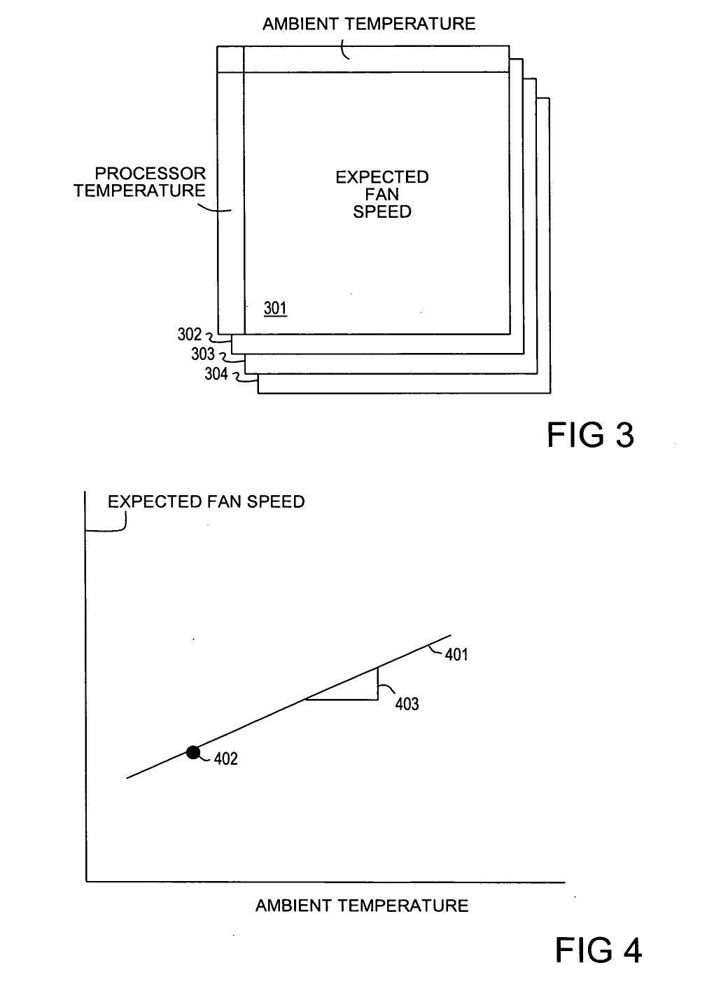

Referring to FIG. 3 and FIG. 4, conceptual representations of the data needed to derive or otherwise obtain an expected fan speed according to different embodiments are shown. In the embodiment depicted in FIG. 3, one or more tables 301 through 304 are stored in a storage element of system 100. Each table 301 through 304 includes a set of expected fan speed values for a given ambient temperature and a targeted microprocessor temperature. Tables 301 through 304 may correspond to different system configurations and/or different levels of power being drawn or dissipated by microprocessor 110. Thus, for example, table 301 provides expected fan speed values for a first power value, second table 302 provides expected fan speed values for a second power value, and so forth. In addition, each table 301-304 may correspond to a particular system configuration where a configuration refers to the specific combination of disk drives and adapter cards (expansion cards). To illustrate, tables 301 and 302 may correspond to first and second power levels of a first system configuration while tables 303 and 304 correspond to first and second power levels of a second system configuration.

Tables 301 through 304 are derived empirically or experimentally in the envisioned embodiment. Obtaining the fan speed values, according to this embodiment, is achieved in a laboratory using a system that is substantially identical to system 100 in terms of its mechanical characteristics and its microprocessor configuration. The laboratory system is maintained in a “like-new” condition so that the heat dissipation mechanism of the system is known to be free of environmental dust and lint and is otherwise in good working condition. The laboratory system may, for example, be a new system or a system that has been maintained in a clean environment.

Using the laboratory system, a table 301 is developed by controlling the ambient temperature and the amount of power dissipated by the laboratory system and by measuring the resulting values of fan speed and microprocessor temperature. The measured value of fan speed under these controlled circumstances becomes the expected value for systems in the field. Under the assumption that the heat dissipation mechanism of the laboratory system is operating as efficiently as possible, the measured fan speed values of the laboratory system provide a bench mark against which fan speed values for other systems can be compared. If a system in the field requires a significantly higher fan speed to achieve a given microprocessor temperature for a given ambient temperature and power dissipation level, a heat dissipation problem is assumed.

Each table 301 through 304 depicted in FIG. 3 is derived for a given level of power dissipation. As described below, the power dissipation of microprocessor 110 is controlled by executing known pieces of code (referred to herein as thermal code) where the thermal code is known to cause microprocessor 110 to dissipate a certain level of power. In the preferred embodiment, the tables 301 through 304 are created using the same piece or pieces of thermal code that will execute in the field during heat dissipation verification sequences.

Referring now to FIG. 4, an alternative embodiment of the invention is represented by a single line and point. In this embodiment, a system such as system 100 derives its own expected fan speed values by performing a fan speed determination when the system is in a like-new condition. As an example, system 100 may derive its own expected fans speed values by determining one or more fan speed values when the system is first booted. This embodiment makes an assumption that the heat dissipation elements are substantially free of environmental contaminants and are otherwise in like-new condition when the system is booted in the field for the first time.

In the embodiment represented by FIG. 4, a single value of fan speed is determined when the system is booted in the field for the first time. During the boot sequence, a piece of thermal code is executed to force the microprocessor to dissipate or consume a known (or at least a repeatable) level of power. The thermal code executes in a loop until thermal stability is achieved, at which time the system measures the ambient temperature, the fan speed, and the microprocessor temperature. These values provide a single data point 402 correlating fan speed to ambient temperature. System 100 can expand single data point 402 to create the line 401. Specifically, if the slope 403 of line 401, which has been previously characterized in the laboratory for a system like system 100, is stored in a storage element, the single point 402, together with the slope 403, is sufficient to define line 401. Line 401 can then be consulted to determine an expected fan speed value for a given ambient temperature. Over the expected range of ambient temperatures that a conventional computer system is likely to encounter, the assumption of a linear relationship between expected fan speed value and ambient temperature is likely to provide sufficient accuracy. If, however, a non-linear relationship is thought to describe the relationship more accurately, parameters of the non-linear relationship may be stored in system 100 and used to calculate various expected fan speed values.

Thus, FIG. 3 above depicts an embodiment in which all of the relevant data for determining expected fan speed values is provided in a stored table and FIG. 4 depicts an embodiment in which only a single value (the system's characteristic fan speed/ambient slope) is provided. Other implementations may take interim positions in how much stored data is required to implement the present invention. For example, one implementation may store a single table such as table 301 that represents the expected fan speed values for a particular level of power. If the actual power consumed during operation in the field varies from the power that forms the basis of table 301, system 100 may extrapolate an expected fan speed value from a fan speed value retrieved from the table. One implementation would derive all relevant information during the initial boot sequence. In this example, the system might require a somewhat elaborate initial boot sequence in which the user boots in two ambient temperature environments. From readings derived from these two data points, the system could determine its own characteristic slope 403. In another example, the system determines actual fan speed values for two different levels of power consumption (presumably at a single ambient) and derives a characteristic slope 403 from the two data points. While this implementation might produce a slope 403 that is somewhat less accurate than a method that uses two or more different ambient temperatures, it beneficially simplifies the process by requiring only a single ambient temperature at initial startup. What is common to all such implementations is that system 100 either through derivation, reference to a table of stored values, or a combination of both, is able to predict the expected fan speed for at least one set of conditions (i.e., at least one ambient temperature, power consumption level, and targeted microprocessor temperature) and preferably for multiple sets of conditions.

Portions of the present invention are most likely implemented as a set or sequence of computer executable instructions (computer software) stored on a computer readable medium. The computer readable medium could be a hard disk or other persistent storage element on the system itself. During periods the instructions are being executed by the microprocessor, portions of the instructions may be stored in a volatile storage element such as a DRAM-based system memory or an SRAM-based cache memory (internal or external) When executed, these instructions are configured to determine the microprocessor fansink fan speed that is required to achieve a targeted microprocessor temperature for a given ambient temperature. The instructions, when executed, are further able to compare the required fan speed to an expected fan speed and to take corrective action when the required fan speed exceeds the expected fan speed by some threshold value.

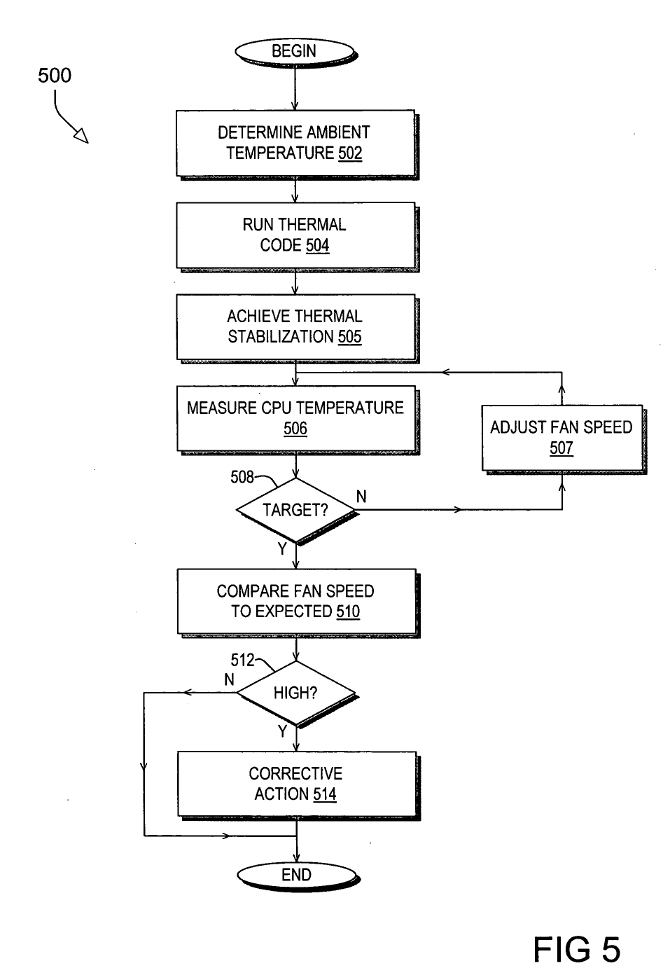

Referring to FIG. 5, a flow diagram is presented to illustrate a method or process 500 performed by a data processing system such as system 100 described above when the computer program product is executed. In the depicted embodiment, method 500 includes determining (block 502) the ambient temperature of the system. The ambient temperature is preferably determined from a first temperature sensor (see element 108 of FIG. 2) that is positioned within the system to detect the temperature most representative of the ambient temperature. In some implementations, for example, the first sensor is positioned adjacent an external vent port.

As depicted in FIG. 5, method 500 further includes executing (block 504) a code segment or set of code segments referred to herein as the thermal code. In one embodiment, the thermal code is specifically designed to exercise the microprocessor in a manner that results in constant or approximately constant power consumption by the microprocessor. The thermal code may include, as one example, a routine that loops endlessly while exercising a unit of the microprocessor, such as a floating point arithmetic unit, that consumes significant power. It is not necessary, however, that the thermal code exercise the microprocessor to an extreme power consumption level, but only that it exercise the microprocessor to produce a relatively stable level of power consumption.

Achieving the desired power consumption may be accomplished in one embodiment, by preventing or prohibiting all other code segments from executing when the thermal code is executing. While such an embodiment enjoys the benefit of eliminating considerations of power consumption attributable to other executing threads or processes, it would suffer the significant disadvantage of having a detrimental impact on system performance. The latter concern may be alleviated by executing the thermal code only infrequently or only during time periods when the loading on the system is expected to be low. The thermal code might, for example, execute only when a system is re-booted or only during periods late at night when demand is expected to be low. A variation on this embodiment would initiate the heat dissipation verification method and exercise the thermal code only when a specified minimum period of inactivity has been detected.

Problems associated with power consumption attributable to other code executing simultaneously or concurrently with the thermal code might also be addressed by designing the thermal code to dominate the resulting microprocessor power consumption relative to other types of code that typically execute on the system. Whereas typical code, for example, might be dominated by fixed point load and store instructions and latency caused by inevitable cache misses may be considerable, the thermal code according to the present invention may be designed to eliminate cache miss latency (by using repeated memory references for example) and to consist largely of floating point or other arithmetic instructions that tend to exercise the microprocessor more robustly than conventional code segments. Moreover, system 100 may include two or more pieces of thermal code, each of which is configured to produce a corresponding level of power consumption.

As shown in FIG. 5, the thermal code is executed for a duration sufficient to achieve (block 505) a thermally stable microprocessor temperature, at least to a first or second order of approximation. While the thermal code is executing, the microprocessor temperature may approach a stable value asymptotically and may take several minutes to achieve complete stability. In the interest of minimizing the downtime associated with heat dissipation method 500 according to one embodiment of the invention, the thermal code may be executed for a duration that is on the order of several seconds and the resulting temperatures are assumed to be relatively stable values that are acceptable for purposes of determining the functionality and performance of the heat dissipation apparatus.

Upon achieving a sufficiently stabilized thermal condition, the microprocessor temperature is measured (block 506) and compared (block 508) against a targeted value. The targeted value is a microprocessor temperature for which an expected fan speed value is known (i.e., stored in a table such as table 301) or may be derived algorithmically such as is shown in FIG. 4. A given implementation may have one or multiple targeted microprocessor values. If the measured value of the microprocessor does not equal the targeted value, the fan speed is adjusted (block 507) until the desired microprocessor temperature is achieved. If the microprocessor temperature is above the targeted value, the fan speed is increased. Conversely, if the targeted microprocessor temperature is below the targeted value, the fan speed is decreased. Adjustment of the fan speed is controlled by microprocessor 110, perhaps in conjunction with a simple device driver or BIOS code dedicated to the fansink fan. In a likely embodiment, the fansink fan will be operable in one of multiple discreet fan speed settings. As discussed previously, measurement of the microprocessor temperature is achieved in one embodiment, using a dedicated transistor within the microprocessor. A pair of leads connected to this dedicated transistor may be read by the microprocessor to determine a transistor voltage or current that is indicative of the transistor's junction temperature, which may be used as a proxy for the microprocessor temperature.

When the measured microprocessor temperature equals the targeted temperature, the fan speed value is compared (block 510) against an expected fan speed value. The expected fan speed value may be retrieved from a table such as table 301 (FIG. 3) using the ambient temperature, power consumption level, and microprocessor temperature as input values. Alternatively, the expected fan speed value may be derived algorithmically using an equation such as an equation for the line 401 depicted in FIG. 4 and an input parameter such as the ambient temperature.

If the actual fan speed required to maintain the microprocessor at a given temperature exceeds (block 512) the expected fan speed, corrective action is taken (block 514). The corrective action may range from issuing a visually or audibly detectable alert to the user to forcing a system shutdown at another. The corrective action may be commensurate with the level of disparity between the expected fan speed and the required fan speed. A small departure from the expected fan speed may warrant a low level corrective action such as informing the user, while a significant departure of fan speed may warrant heightened corrective action including forced shutdown if the integrity of the microprocessor is felt to be compromised.

A variation of the method 500 described above may be suitably employed in the case of a fixed speed fan. If the fansink fan is not variable, a comparison may be made between the measured temperature of the microprocessor and an expected temperature such as a temperature observed in the laboratory under similar conditions or the measured temperature that was observed when the system was first booted. In this case, corrective action is taken if the measured temperature value exceeds the expected temperature value.

It will be apparent to those skilled in the art having the benefit of this disclosure that the present invention contemplates a system and mechanism for verifying the integrity of the heat dissipation components of a data processing system. It is understood that the form of the invention shown and described in the detailed description and the drawings are to be taken merely as presently preferred examples. It is intended that the following claims be interpreted broadly to embrace all the variations of the preferred embodiments disclosed.

What is claimed is:

1. A data processing system, comprising:
a microprocessor connected to a printed circuit board;
a fansink positioned on an upper surface of the microprocessor;
means for exercising the microprocessor to draw a predetermined level of power; and
means for determining that a fan speed required to maintain the microprocessor at a targeted temperature, while the microprocessor is drawing the predetermined power level, exceeds an expected fan speed.

2. The data processing system of claim 1, wherein the means for exercising the microprocessor includes means for executing a dedicated piece of code continuously until the microprocessor temperature stabilizes.

3. The data processing system of claim 1, wherein the determining means includes means for accessing a stored table of expected fan speed values, wherein the table is indicative of the expected fan speed for various ambient temperatures and microprocessor temperatures.

4. The data processing system of claim 3, further comprising additional fan speed value tables wherein each table is indicative of the expected fan speeds for a corresponding level of microprocessor power consumption.

5. The data processing system of claim 1, wherein the determining means includes:
means for generating an algorithm during an initial boot of the system; and
means for using the algorithm to derive the expected fan speed values.

6. The data processing system of claim 5, wherein the algorithm comprises a linear algorithm that generates an expected fan speed value from an ambient temperature.

7. The data processing system of claim 6, wherein the means for generating the algorithm include means for determining a fan speed value at a single ambient temperature and means for deriving the linear algorithm from the single data point.

8. A computer program product comprising computer executable instructions, stored on a computer readable medium, for verifying heat dissipation apparatus of a data processing system, comprising:
computer code means for determining an ambient temperature from a first temperature sensor and for determining a temperature of a microprocessor of the data processing system from a second temperature sensor;
computer code means for causing the microprocessor to consume a specific level of power;
computer code means for determining an expected fan speed at which the microprocessor temperature is expected to be less than or equal to a targeted microprocessor temperature;
computer code means for adjusting the speed of a fan element of a fansink assembly until the microprocessor temperature is less than or equal to the targeted temperature; and
computer code means for initiating corrective action if the adjusted fan speed exceeds the expected fan speed.

9. The computer program product of claim 8, wherein the computer code means for determining the expected fan speed value comprises computer code means for retrieving an expected fan speed value from a fan speed table stored in persistent storage of the system.

10. The computer program product of claim 9, wherein the expected fan speed table is determined empirically using a model system substantially similar to the data processing system under conditions that ensure the heat dissipation apparatus of the model system are substantially free of environmental particles.

11. The computer program product of claim 10, further comprising multiple expected fan speed tables stored in persistent memory, wherein the computer code means for determining the expected fan speed value includes computer code means for selecting the table corresponding to the known level of power.

12. The computer program product of claim 8, wherein the computer code means for determining the expected fan speed value comprises computer code means for determining, during an initial boot sequence, a fan speed value required to achieve the targeted microprocessor temperature and, thereafter, using the initially determined fan speed value to generate the expected fan speed value.

13. The computer program product of claim 12, wherein the computer code means for determining the expected fan speed value includes computer code means for deriving from the initially determined fan speed value a linear equation for expected fan speed value as a function of ambient temperature.

14. The computer program product of claim 13, wherein the computer code means for deriving the linear equation includes computer code means for retrieving a slope value, characteristic of the change in expected fan speed over the change in ambient temperature, from persistent storage.

15. The computer program product of claim 8, wherein the computer code means for causing the microprocessor to consume a specific level of power includes computer code means for executing a thermal code segment configured to dominate the power consumption of the microprocessor.

16. The computer program product of claim 8, wherein the thermal code continuously exercises a floating point arithmetic unit of the microprocessor.

17. A method of verifying heat dissipation elements of a data processing system, comprising:
determining at least one characteristic indicative of the relationship between ambient temperature and expected fan speed value, wherein the expected fan speed value represents a fan speed required to maintain a microprocessor of the data processing system at or below a targeted temperature when the system is at specified ambient temperature and consuming a known level of power;
storing the at least one characteristic value in storage of the data processing system;
responsive to a boot event, retrieving the at least one characteristic from storage and using the retrieved value to generate an expected value of fan speed required to maintain the microprocessor at or less than the targeted microprocessor temperature when the system is at the specified ambient temperature and consuming the known level of power; and
adjusting the fan speed value until the microprocessor is at or below the targeted temperature and then comparing the adjusted fan speed value to the expected fan speed value.

18. The method of claim 17, wherein the at least one characteristic comprises determining a slope of the data processing system, wherein the slope is indicative of the relationship between a change in ambient temperature and the corresponding change in expected fan speed value.

19. The method of claim 17, wherein determining at least one characteristic comprises determining a table indicative of expected fan speed values for various combinations of ambient temperatures, microprocessor temperatures, and power consumption levels.

20. The method of claim 17, further comprising initiating corrective action if the adjusted fan speed value exceeds the expected fan speed value.
